(19) United States
(12) Patent Application Publication
(10) Pub. No.: US 2018/0259912 A1
(43) Pub. Date: Sep. 13, 2018

(54) ELECTRONIC TIMEPIECE

(71) Applicant: SEIKO EPSON CORPORATION, Tokyo (JP)

(72) Inventor: Kenichi OKUHARA, Kiso-mura (JP)

(73) Assignee: SEIKO EPSON CORPORATION, Tokyo (JP)

(21) Appl. No.: 15/908,120

(22) Filed: Feb. 28, 2018

(30) Foreign Application Priority Data
Mar. 7, 2017 (JP) 2017-042966

(51) Int. Cl. G04G 9/00; G04C 3/00; G04C 3/14; G04G 17/04

(52) U.S. Cl. CPC G04G 9/0064; G04C 3/008; G04B 19/065; G04G 17/045; G04C 3/14

(57) ABSTRACT

In an electronic timepiece, a dial ring is disposed in an outer peripheral portion of a dial inside an exterior case. Opening portions are disposed in the dial ring. An inner rotation ring is rotatably disposed inside the dial ring. A plurality of additional displays for displaying display content other than time are disposed in the inner rotation ring. One of the plurality of additional displays is visible through the opening portions by rotating the inner rotation ring. The electronic timepiece includes a control unit that controls a rotation amount of the inner rotation ring and an indicating hand that indicates the additional display.

### CROSS-REFERENCE TO RELATED APPLICATION

This application claims priority from Japanese patent application JP 2017-042966 filed Mar. 7, 2017, which is incorporated herein by reference in its entirety.

### BACKGROUND

### 1. Technical Field

The present invention relates to an electronic timepiece having a function to display information other than time information.

### 2. Related Art

As an electronic timepiece in the related art, an electronic timepiece is known which displays temperature or atmospheric pressure measured by a sensor in addition to a time display function. In this electronic timepiece, a dial around which times are marked generally includes small windows in order to display other information. The electronic timepiece has a display unit in which each small window includes an indicating hand (refer to JP-A-2016-176957).

As another electronic timepiece in the related art, for example, JP-A-2014-102189 discloses an electronic timepiece. In this electronic timepiece in the related art, a plurality of opening portions are disposed in a main dial having marked time scales, and an auxiliary display plate is rotatably disposed in a back surface of the main dial so as to be concentric with the main dial. This auxiliary display plate is configured so that display modes, for example, which indicate the day of the week, the month, the lunar calendar (lunar phase), and auxiliary display content thereof, are divided and marked in a circumferential direction. For example, in a case of displaying the day of the week, an auxiliary display plate is rotated so as to expose a display surface on which the day of the week is marked in the opening portion disposed in the main dial, and the indicating hand disposed in the opening portion is configured to indicate the day of the week. In a case of displaying the other information, the auxiliary display plate is rotated so as to display the month or the lunar calendar.

Incidentally, the electronic timepiece disclosed in JP-A-2016-176957 includes one or more small windows for displaying information other than time information around a central axis of a dial for displaying the time information, and each of the small windows has each indicating hand. In this electronic timepiece, if the number of small windows increases, the information on the dial increases, thereby causing a problem in that the electronic timepiece gives a complicated impression. A size of characters or numbers displayed on the small window becomes smaller, and thus, display content is less likely to be distinguished.

The numbers, the characters, and the respective indicating hands which are displayed on the small window and which display the information other than the time information may be covered by an hour hand, a minute hand, or a second hand which displays the time information. Consequently, there is a possibility that a user may have difficulties in distinguishing the display content indicated by the small windows and the indicating hands which display the information other than the time information.

On the other hand, in an electronic timepiece disclosed in JP-A-2014-102189, an opening portion is disposed in a dial for displaying the time information, and an auxiliary display plate is rotatably disposed on a back side of the dial through the opening portion, thereby fulfilling a function to display content other than a time display function. According to the electronic timepiece in which a display surface of an auxiliary dial is exposed and displayed from the opening portion, it is difficult to further add a multiple display function.

### SUMMARY

An advantage of some aspects of the invention is to clearly display content other than time information. Another advantage is that an electronic timepiece previously having a display function other than a time display function can additionally have the other display function.

An aspect of an electronic timepiece according to the invention has a display function other than a time display function. The electronic timepiece includes a dial ring disposed in an outer peripheral portion of a dial inside an exterior case, an opening portion disposed in the dial ring, an inner rotation ring rotatably disposed inside the dial ring, and including an additional display having marked display content visible through the opening portion, a control unit that controls a rotation amount of the inner rotation ring, and an indicating hand that indicates the additional display.

According to the aspect of the electronic timepiece, the control unit causes the additional display having the marked display content in the inner rotation ring to be exposed outward through the opening portion disposed in the dial ring, and causes the indicating hand to indicate the additional display. In this manner, the electronic timepiece can display the display content other than the time information to a user.

According to the aspect of the electronic timepiece, the additional display is disposed in the inner rotation ring located on the outer peripheral side of the dial for displaying the time information. Accordingly, compared to a case where numbers are displayed on a small window on the dial, scale intervals can be widened and displayed, and the display content other than the time information can be clearly and more easily displayed. The display on the dial can be simplified, thereby leading to an improved aesthetic sense. According to the aspect, the content other than the time information is displayed on the outer peripheral portion rather than the dial. Therefore, even in a case where the electronic timepiece previously has a display unit for displaying information other than the time information which includes the small window inside the dial, the other information can be further displayed to a user.

In the aspect of the electronic timepiece, it is preferable that a plurality of additional displays having mutually different items to be displayed are dispersedly arranged in the inner rotation ring in a circumferential direction. It is preferable that the inner rotation ring is rotated by operating an operation member attached to the exterior case so that one of the plurality of additional displays is exposed in the opening portion disposed in the dial ring.

In this way, the plurality of additional displays respectively having a plurality of types of the display content marked in the inner rotation ring are dispersedly arranged in the circumferential direction, and one of the additional displays is selectively displayed. In this manner, the plurality of types of the display content other than the time information can be selectively displayed.

In the aspect of the electronic timepiece, it is preferable that the dial ring has a pair of opening portions including the opening portion, which are symmetrically arranged with respect to a center point of a circle of the dial ring.

In this way, the pair of opening portions is disposed in the dial ring. In this manner, the two additional displays can simultaneously display the display content, thereby enabling the more types of the display content to be displayed.

In the aspect of the electronic timepiece, it is preferable that the inner rotation ring has a pair of the additional displays having the same display item and having mutually different numerical ranges, which are symmetrically arranged with respect to the center point of the circle of the inner rotation ring. It is preferable that each of the pair of additional displays is exposed in each of the pair of opening portions so that the indicating hand indicates one of the pair of additional displays.

In this way, in the inner rotation ring, the additional displays having the item to be displayed in the different numerical range are dispersedly arranged symmetrically with the central axis perpendicular to the circumferential direction of the circle of the inner rotation ring, the item to be displayed is displayed on the pair of opening portions disposed in the dial ring. In this manner, a range displayed by the additional displays is enlarged and displayed. Therefore, the display is more visible.

In the aspect of the electronic timepiece, it is preferable that the dial ring includes an end surface having a shape perpendicular to a surface of the dial, an inclined surface having a shape obliquely rising from the end surface toward an outer peripheral side of the dial ring, and an upper surface disposed in a flat shape from the outer peripheral side of the inclined surface toward the outer peripheral side of the dial ring. It is preferable that the inner rotation ring includes an end surface, an inclined surface, and it is preferable that an upper surface which respectively correspond to the end surface, the inclined surface, and the upper surface of the dial ring. It is preferable that the end surface, the inclined surface, and the upper surface of the dial ring each have an opening portion. It is preferable that the additional displays are disposed in the end surface, the inclined surface, and the upper surface of the inner rotation ring so as to respectively correspond to the end surface, the inclined surface, and the upper surface of the dial ring.

In the aspect of the electronic timepiece, it is preferable that the dial ring includes two surface portions among an end surface having a shape perpendicular to a surface of the dial, an inclined surface having a shape obliquely rising from the end surface toward an outer peripheral side of the dial ring, and an upper surface disposed in the flat shape from the outer peripheral side of the inclined surface toward the outer peripheral side of the dial ring. It is preferable that the inner rotation ring includes two surface portions respectively corresponding to the two surface portions of the dial ring. It is preferable that the two surface portions included in the dial ring have the opening portion. It is preferable that the additional displays are disposed in the two surface portions included in the inner rotation ring so as to respectively correspond to the respective opening portions of the dial ring.

In this way, the dial ring and the inner rotation ring respectively include the two surface portions among the end surface, the inclined surface, and the upper surface, each portion of the dial ring has the opening portion, and each portion of the inner rotation ring has the additional display. In this manner, the display content other than the time information is easily understood.

In the aspect of the electronic timepiece, it is preferable that as an indicating hand for indicating the additional display, a second hand is used in common. It is preferable that an operation member is attached to the exterior case, and the control unit has a function to switch a time display using the second hand to indication of the additional display by operating the operation member.

In this way, the second hand is used in common as the indicating hand of the additional display. In this manner, a dedicated indicating hand is not required, thereby allowing a configuration of the electronic timepiece to be simplified.

### BRIEF DESCRIPTION OF THE DRAWINGS

The invention will be described with reference to the accompanying drawings, wherein like numbers reference like elements.

FIG. 1 is a plan view illustrating an embodiment of an electronic timepiece according to the invention.

FIG. 2 is a partial longitudinal sectional view illustrating the electronic timepiece according to the present embodiment.

FIG. 3A is a partial perspective view illustrating a combination structure between a dial ring and an inner rotation ring according to the present embodiment, and FIG. 3B is a partial development diagram illustrating the combination structure.

FIG. 4 is a development diagram illustrating an arrangement of opening portions of the dial ring according to the present embodiment.

FIG. 5 is a development diagram illustrating an arrangement of additional displays of the inner rotation ring according to the present embodiment.

FIG. 6 is a control block diagram according to the present embodiment.

FIG. 7 is a flowchart for describing an operation according to the present embodiment.

FIG. 8 is a plan view of an inner rotation ring, which illustrates another embodiment of the electronic timepiece according to the invention.

FIG. 9 is a plan view illustrating another embodiment of the electronic timepiece according to the invention.

FIG. 10 is a plan view illustrating an inner rotation ring according to the embodiment illustrated in FIG. 9.

### DESCRIPTION OF EXEMPLARY EMBODIMENTS

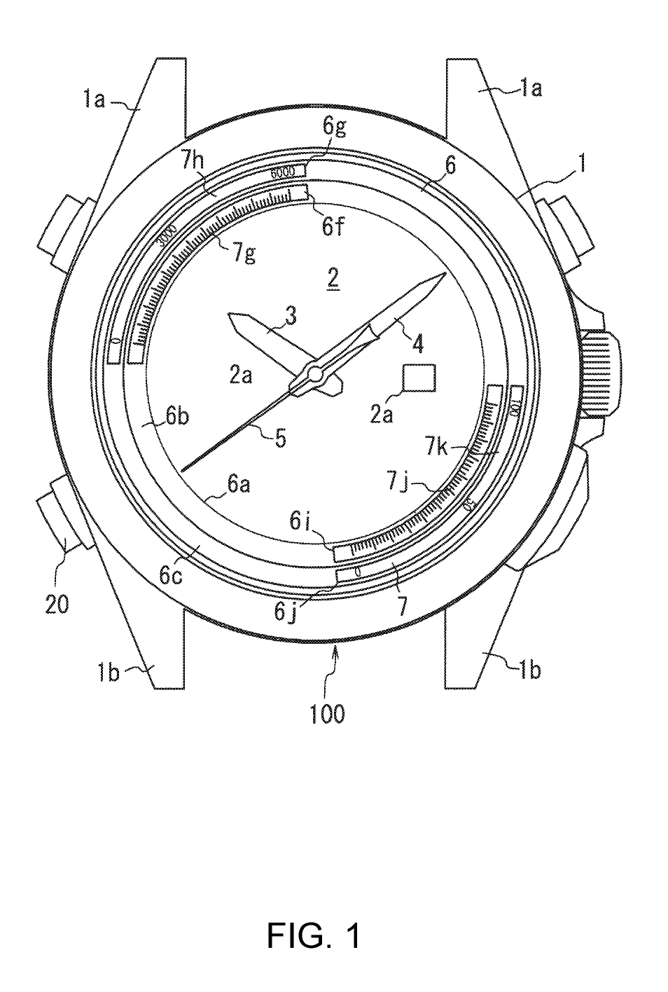

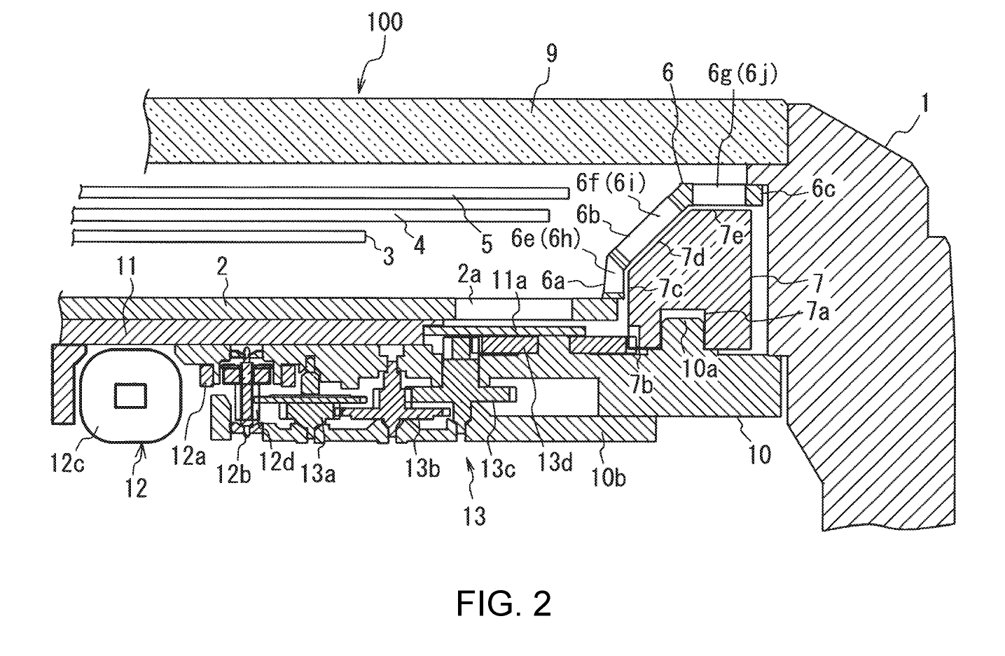

FIG. 1 is a plan view illustrating an embodiment of an electronic timepiece according to the invention by omitting a cover glass on an upper surface. An electronic timepiece 100 includes an exterior case 1 in a substantially annular shape, and the exterior case 1 includes an attachment portion for attaching a band (not illustrated) to the exterior case 1. The electronic timepiece 100 includes a dial 2 having time displays (not illustrated) marked in an outer peripheral portion. The dial 2 includes a small window 2a through which a portion having the marked date of a date indicator 11a (refer to FIG. 2) is exposed. The electronic timepiece 100 includes an hour hand 3, a minute hand 4, and a second hand 5. A dial ring 6 is disposed in the outer peripheral portion of the dial 2 inside the exterior case 1.

FIG. 2 is a partial longitudinal sectional view illustrating the electronic timepiece according to the present embodiment. An inner rotation ring 7 is rotatably disposed inside the dial ring 6. A cover glass is fixed to an upper surface of the exterior case 1. Inside the exterior case 1, amain plate 10 for mounting configuration components is fixed, and a date indicator maintaining plate 11 and a date indicator 11a are attached to the main plate 10. A rail 10a having an arc shape is disposed on an upper surface of the main plate 10. A groove 7a disposed in an arc shape on a lower surface of the inner rotation ring 7 is slidably fitted to the rail 10a.

A motor 12 for rotating the inner rotation ring 7 is attached to the main plate 10. The motor 12 has a stator 12a, a rotor 12b, and a coil block 12c. The motor 12 is a stepping motor. A train wheel 13 formed from gears 13a to 13d for decelerating a rotation force and transmitting the rotation force of the motor 12 to the inner rotation ring 7 is disposed between a gear 12d disposed in an output axle of the rotor 12b and an internal gear 7b disposed in the inner rotation ring 7. Therefore, if the motor 12 is driven, the inner rotation ring 7 is rotated along the rail 10a.

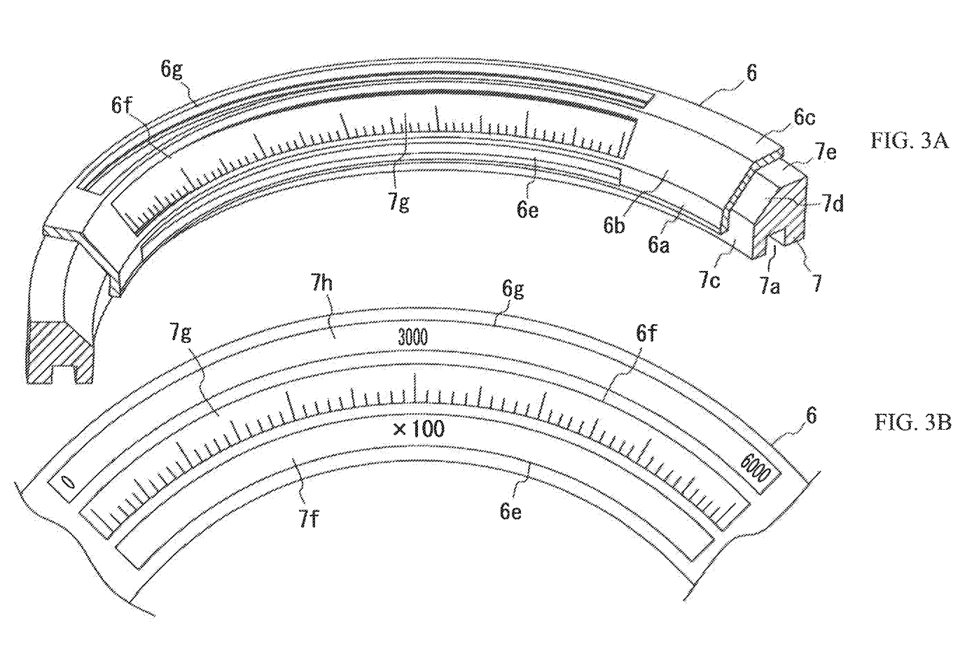

As illustrated in FIGS. 2 and 3A, the dial ring 6 has an end surface 6a having a shape substantially perpendicular to a surface of the dial 2, an inclined surface 6b having a shape obliquely rising from the end surface 6a toward an outer peripheral side of the dial ring 6, and an upper surface 6c formed in a substantially flat shape from the outer peripheral side of the inclined surface 6b toward the outer peripheral side of the dial ring 6.

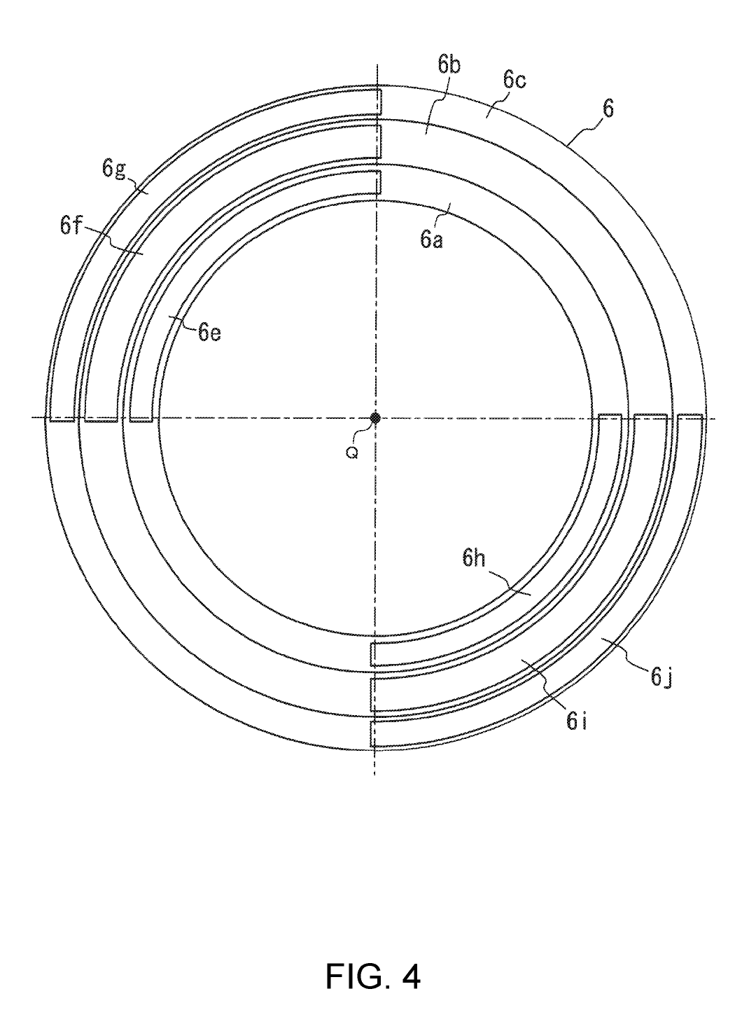

As illustrated by a development diagram in FIG. 4, in the present embodiment, in the end surface 6a, the inclined surface 6b, and the upper surface 6c of the dial ring 6, opening portions 6e, 6f, and 6g respectively having one arc shape are disposed at the same angular position in a circumferential direction and within an angular range of approximately 90 degrees. In contrast to the opening portions 6e, 6f, and 6g, other opening portions 6h, 6i, and 6j are disposed at positions symmetrical with respect to a center point Q of a circle of the dial ring 6. The opening portions 6h, 6i, and 6j are located at the same angular position in the circumferential direction and in a range of approximately 90 degrees.

As illustrated in FIGS. 2 and 3A, the inner rotation ring 7 includes an end surface 7c, an inclined surface 7d, and an upper surface 7e which respectively face the end surface 6a, the inclined surface 6b, the upper surface 6c of the dial ring 6.

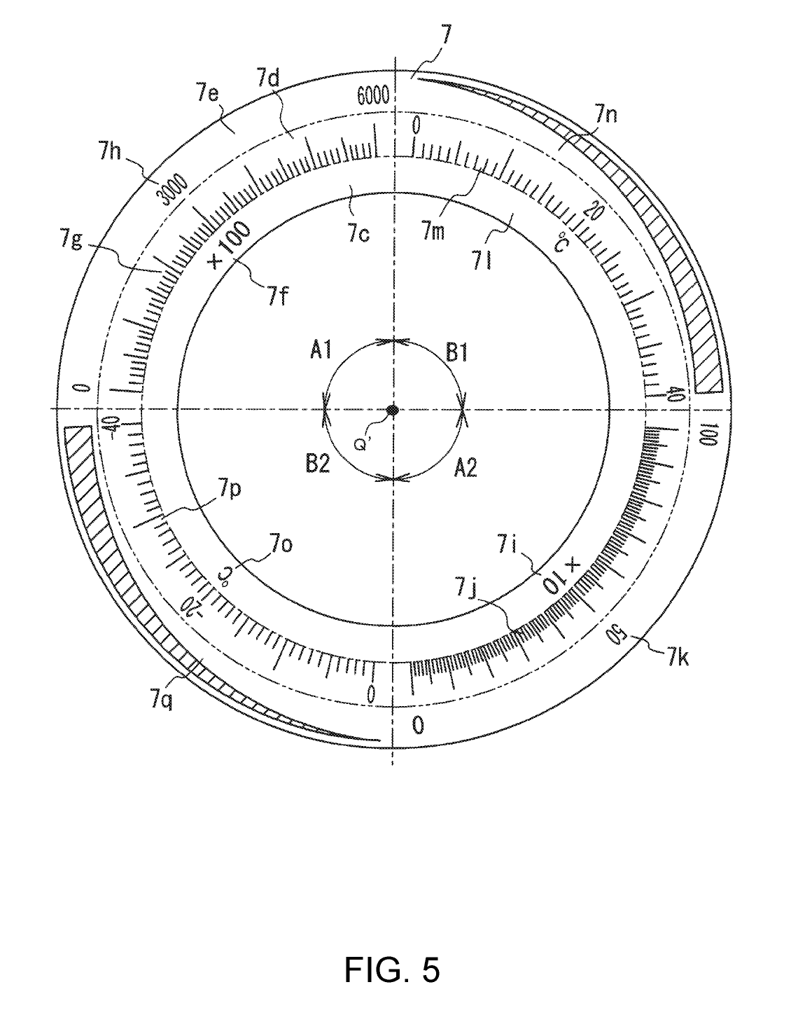

As illustrated by a development diagram in FIG. 5, two of a display range A1 and a display range A2 are disposed in the end surface 7c, the inclined surface 7d, and the upper surface 7e of the inner rotation ring 7. The display range A1 has additional displays 7f, 7g, and 7h, and the display range A2 has additional displays 7i, 7j, and 7k. The additional displays 7f, 7g, and 7h, and 7i, 7j, and 7k are arranged at the same position in the circumferential direction of the inner rotation ring 7. The additional displays 7f, 7g, and 7h and the additional displays 7i, 7j, and 7k are arranged symmetrically with respect to a central axis Z′ perpendicular to the circumferential direction of the circle of the dial ring 6.

The other two display ranges B1 and B2 at approximately 90 degrees in the inner rotation ring 7 have the other additional displays 7l, 7m, and 7n and 7o, 7p, and 7q. The additional displays 7l, 7m, and 7n and 7o, 7p, and 7q are respectively disposed in the display ranges B1 and B2 which are located at the same position in the circumferential direction of the inner rotation ring 7 and at an angle of approximately 90 degrees. The additional displays 7l, 7m, and 7n and 7o, 7p, and 7q are arranged symmetrically with respect to the central axis Z′ perpendicular to the circumferential direction of the circle of the dial ring 6.

In the present embodiment, the display ranges A1 and A2 of the inner rotation ring 7 displays an altitude measured from the atmospheric pressure by a pneumatic pressure sensor (not illustrated) accommodated inside the exterior case 1 or externally attached to the exterior case 1. The altitude displayed one display range A1 is in a range of 0 m to 6,000 m, and the altitude displayed in the other display range A2 is in a range of 0 m to 100 m. Scales of 0 m to 6,000 m and 0 m to 100 mare respectively marked in the additional displays 7g and 7j in the inclined surface 7d. Numbers corresponding to the scales are marked in the additional displays 7h and 7k in the upper surface 7e. In this example, the additional displays 7f and 7i in the end surface 7c displays the magnification of the scales. However, a unit of the altitude such as m (meter) or a mode name such as the “altitude” may be marked. The display ranges A1 and A2 may display a height different from the above-described range. For example, the display range A2 may display a negative value corresponding to an underground depth.

The remaining display ranges B1 and B2 in the inner rotation ring 7 displays temperature measured by a temperature sensor (not illustrated) accommodated inside the exterior case 1 or externally attached to the exterior case 1. In this example, the temperature displayed on one display range B1 is in a range of 0° to 40°, and the temperature displayed on the other display range B2 is in a range of 0° to −40°. Characters displayed as “° C.” of the temperature unit as a display target mode are marked in the additional displays 7l and 7o in the inner rotation ring 7. Scales in the range of 0° to 40° and 0° to −40° are respectively marked in the additional displays 7m and 7p. Symbols (for example, as illustrated, symbols whose width increases as the temperature is higher or lower than 0°) corresponding to the detected temperature are marked in the additional displays 7n and 7q.

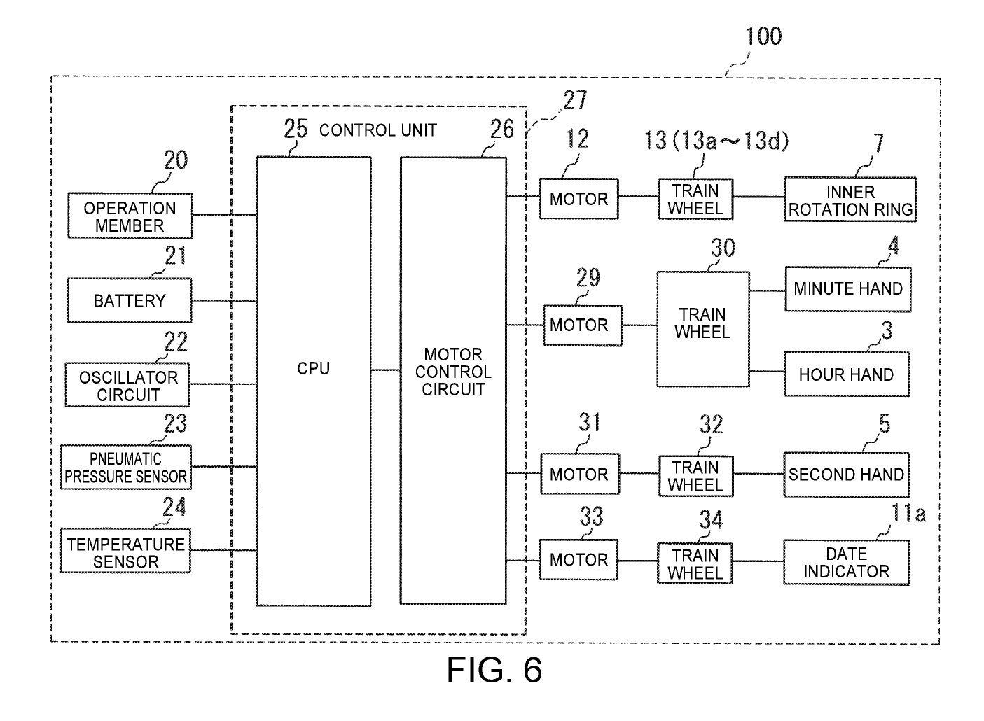

As illustrated in FIG. 1, the electronic timepiece 100 includes an operation member 20. The operation member 20 includes a push button, and controls an operation of the motor 12 for rotating the inner rotation ring 7. The operation member 20 internally includes a switch, and outputs an operation signal in accordance with an operation of a user. As illustrated in FIG. 6, the electronic timepiece 100 includes a battery 21, an oscillator circuit 22 for generating a clock signal, a pneumatic pressure sensor 23, and a temperature sensor 24. The electronic timepiece 100 further includes a central processing unit (CPU) 25 (processor) and a motor control circuit 26, thereby configuring a control unit 27.

The electronic timepiece 100 includes a motor 29 for driving the hour hand 3 and the minute hand 4 via a train wheel 30. The electronic timepiece 100 includes a motor 31 for driving the second hand 5 via a train wheel 32 and a motor 33 for driving the date indicator 11a via a train wheel 34.

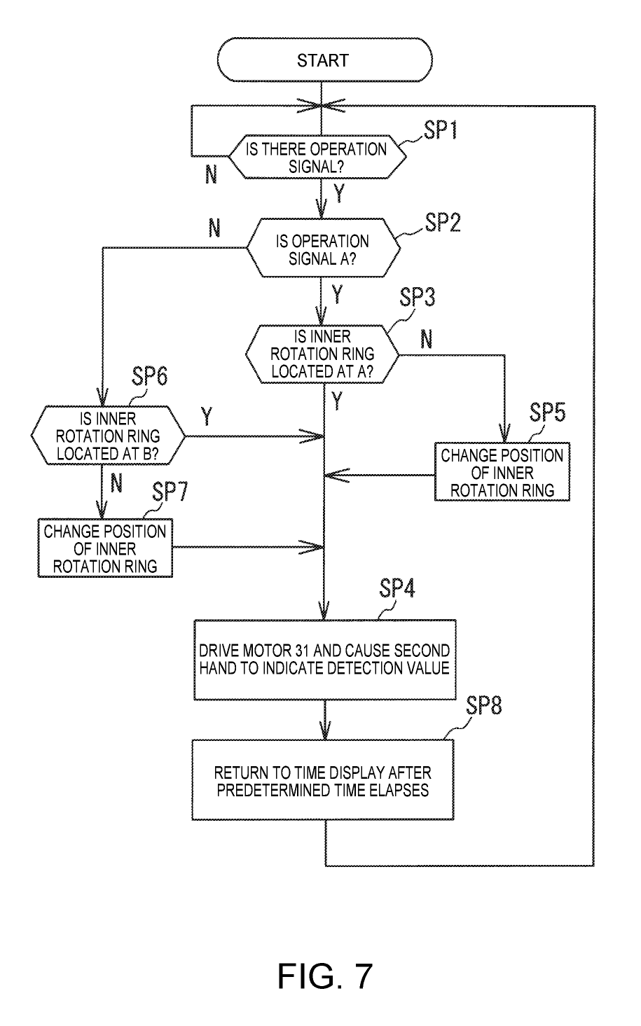

Next, an operation according to the present embodiment will be described with reference to FIG. 7. The electronic timepiece 100 includes a display mode A showing a measurement value measured by the pneumatic pressure sensor for obtaining the altitude and a display mode B showing a measurement value measured by the temperature sensor. First, the CPU 25 determines whether or not there is an operation signal (Step SP1). If the operation member 20 is operated, a determination result in Step SP1 is affirmative, and the CPU 25 determines whether or not the operation signal indicates the display mode A (Step SP2). Here, in a case where the push button is used as the operation member 20, for example, every time the push button is pushed, the display mode is switched to a time display mode, the display mode A, and the display mode B. In this way, it is possible to adopt a method of switching display mode designation. Unlike the pushing type, the operation member 20 can adopt a configuration in which the display mode can be designated a dial type operation member for designating rightward and leftward rotating directions and rotating angles.

In a case of the display mode A, the CPU 25 determines whether a current position of the inner rotation ring 7 is located at a display position of the display mode A (Step SP3). The current position of the inner rotation ring 7 can be recognized by the number of driving pulses supplied to the motor 12 serving as the stepping motor for driving the inner rotation ring 7.

When the current position of the inner rotation ring 7 is located at the display position of the display mode A (altitude), the CPU 25 and the motor control circuit 26 drive the stepping motor serving as the motor 31 for driving the second hand 5. Instead of the time display mode, the second hand 5 is rotated as large as a rotation angle set in accordance with the measurement value so as to indicate the scale corresponding to the measurement value. When the measurement value of the altitude is in a range of 0 m to 100 m, the second hand 5 is rotated in the display range A2 of the dial ring 6, and the second hand 5 indicates the scale of the measured altitude. When the measurement value of the altitude exceeds 100 m, the second hand 5 indicates the scale in the display range A1 of the dial ring 6, and the second hand 5 indicates the scale corresponding to the altitude.

On the other hand, when the position of the inner rotation ring 7 is not located at the display position of the display mode A, the CPU 25 and the motor control circuit 26 drive the motor 12 so that the inner rotation ring 7 is rotated to a position where the additional displays 7f, 7g, and 7h and 7i, 7j, and 7k respectively correspond to the opening portions 6e, 6f, and 6g and 6h, 6i, and 6j of the dial ring 6 (Step SP5).

On the other hand, in a case of the display mode B (temperature) designated by the operation member 20, the CPU 25 determines whether or not the position of the inner rotation ring 7 is located at the display position of the display mode B (Step SP6). If the position of the inner rotation ring 7 is located at the position of the display mode B, the CPU 25 and the motor control circuit 26 drive the motor 31 so that the second hand 5 displays the measurement value (Step SP4).

On the other hand, if the position of the inner rotation ring 7 is not located at the display position of the display mode B, the CPU 25 and the motor control circuit 26 drive the motor 12 so that the position is changed by rotating the inner rotation ring 7 (Step SP7), and thereafter cause the secondhand 5 to display the measurement value (Step SP4). When the measured temperature is in a range of 0° to 40°, the second hand 5 indicates the scale inside the display range B1, and when the temperature is lower than 0° to −40°, the second hand 5 indicates the scale inside the display range B2.

After the lapse of time (for example, 30 seconds from the measurement value display in Step SP4) during which it is considered that a value displayed by the second hand 5 is sufficiently visible to a user, the CPU 25 and the motor control circuit 26 cause the second hand 5 to stop displaying the measurement value. The second hand 5 is returned to the time display mode so as to return to a state of waiting for the operation performed by the operation member 20 (Step SP8).

As described above, in the present embodiment, the additional displays 7f, 7g, and 7h and 7i, 7j, and 7k in which the characters, the scales, or the numbers are marked in the inner rotation ring 7 are respectively exposed outward through the opening portions 6e, 6f, and 6g and 6h, 6i, and 6j of the dial ring 6, and the scales are indicated by the second hand 5 used as the indicating hand. In this manner, the display content other than the time information can be displayed to the user.

The present embodiment adopts a configuration in which the additional displays 7f to 7k and 7l to 7q are arranged in the inner rotation ring 7 located on the outer peripheral side of the dial 2 for displaying the time information so as to be respectively visible through the opening portions 6e to 6j of the dial ring 6. Accordingly, compared to a case where the numbers are displayed on the dial 2, scale intervals can be widened and displayed, and the display content other than the time information can be clearly and more easily displayed. According to the present embodiment, the content other than the time information is displayed on the outer peripheral portion rather than the dial 2. Therefore, the present embodiment is also applicable to a case where the dial 2 internally has a display unit for displaying information other than the time information.

In the present embodiment, the plurality of additional displays 7f to 7k and 7l to 7q respectively having a plurality of display content items marked therein are dispersedly arranged in the inner rotation ring 7 in the circumferential direction, and one of the additional displays is selectively displayed. Therefore, it is possible to display the display content such as a plurality of display modes other than the time information.

In the present embodiment, the additional display 7f to 7k or 7l to 7q having mutually different numerical ranges for the items of one mode to be displayed are diagonally and dispersedly arranged in the inner rotation ring 7, and the items are displayed on the two combinations of the opening portions 6e to 6g and 6h to 6j disposed in the dial ring 6. In this manner, the display content is enlarged and displayed by the additional displays 7f to 7k or 7l to 7q, thereby allowing the display to be easily visible.

As in the present embodiment, the end surface 7c, the inclined surface 7d, and the upper surface 7e of the inner rotation ring 7 respectively have the additional displays 7f to 7k and 7l to 7q. For example, compared to a case where the additional displays are disposed only in the inclined surface 7d, since the inner rotation ring 7 is divided into three surfaces, the display content other than the time information is likely to be understood.

In the present embodiment, an example has been described in which the dial ring 6 has the three surface portions of the end surface 6a, the inclined surface 6b, and the upper surface 6c, and in which the inner rotation ring 7 has the three surface portions of the end surface 7c, the inclined surface 7d, and the upper surface 7e. However, a configuration may be adopted in which the dial ring 6 or the inner rotation ring 7 has only two corresponding surface portions among the three surface portions. A configuration may be adopted in which the opening portions disposed in the dial ring 6 are continuous with each other over mutually adjacent surface portions.

In the present embodiment, the second hand 5 is used in common as the indicating hand for indicating the additional displays, and the exterior case 1 internally includes the control unit 27 which switches the time display mode using the second hand 5 to indicating the additional displays 7f to 7k and 7l to 7q by operating the operation member 20. Therefore, a dedicated indicating hand is not required, thereby allowing a configuration of the electronic timepiece to be simplified.

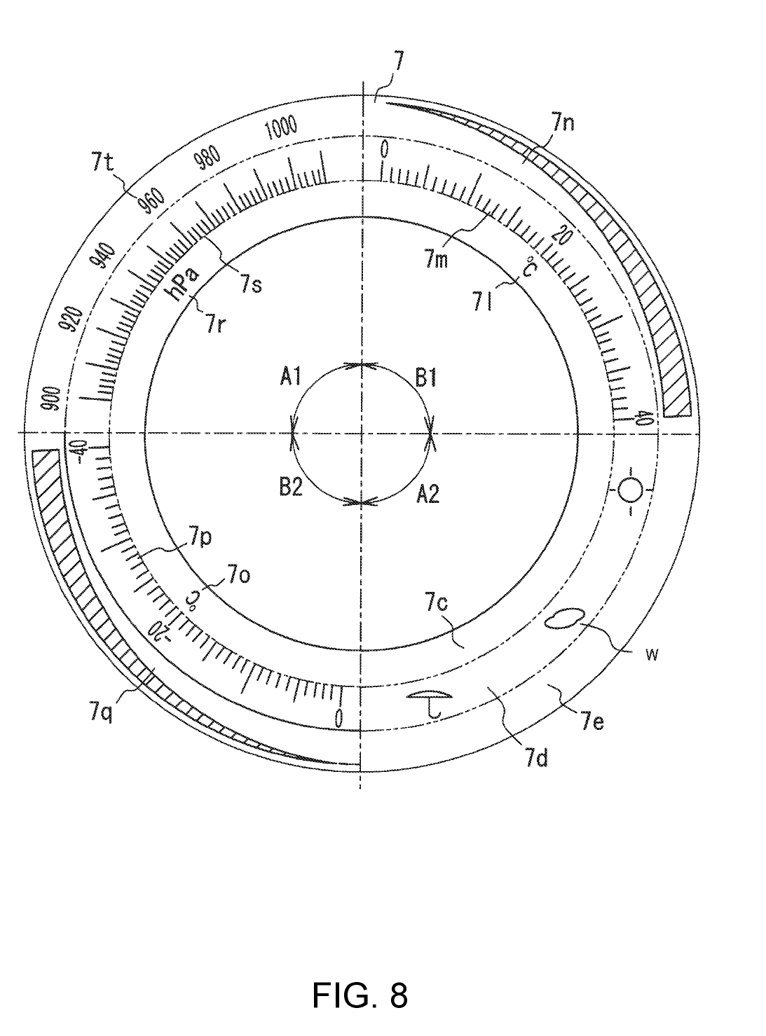

The electronic timepiece according to the invention is also applicable to a case where except for the time display mode, the mode (item) displayed by the additional displays is information other than the altitude or the temperature. FIG. 8 illustrates a configuration example of the inner rotation ring 7 in which atmospheric pressure or weather is the display item instead of the altitude illustrated in the above-described embodiment. In FIG. 8, the display content illustrated in the display ranges B1 and B2 is displayed with regard to temperature, similarly to that illustrated in FIG. 5.

On the other hand, in the display range A1, instead of the altitude, the additional display 7r displays units of the atmospheric pressure, the additional display 7s displays the scales, and the additional display 7t displays the numbers corresponding to the scales. In the display range A2 diagonally facing the display range A1, expected weather information W is displayed using sunny, cloudy, and rainy symbols as illustrated, for example.

In a case where the atmospheric pressure and the weather are selected for display by operating the operation member 20, the additional displays 7r, 7s, and 7t illustrated in FIG. 8 are respectively exposed in the opening portion 6e, 6f, and 6g of the dial ring 6 illustrated in FIG. 4, and the additional display 7n is exposed in the opening portion 6i. The atmospheric pressure is displayed by causing the second hand 5 to indicate the additional display 7s, and is displayed for a prescribed period of time. Thereafter, the second hand 5 is rotated so as to indicate the symbol of the additional display 7n for indicating the weather. In addition to the pushing operation, a rotating operation may be added to an operation mode of the operation member 20. In this manner, the operation may select any one of causing the second hand 5 to indicate the additional display 7r, 7s, and 7t or causing the second hand 5 to indicate the additional display 7s.

In this way, a configuration is adopted in which the opening portions forming a pair display the two additional displays having mutually different items to be displayed. Accordingly, the more items can be displayed.

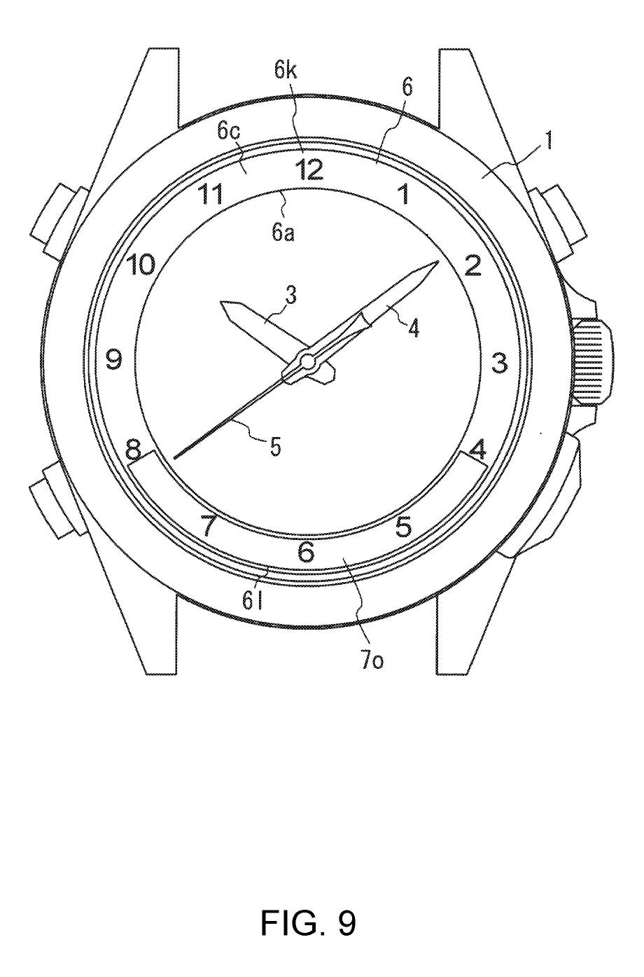

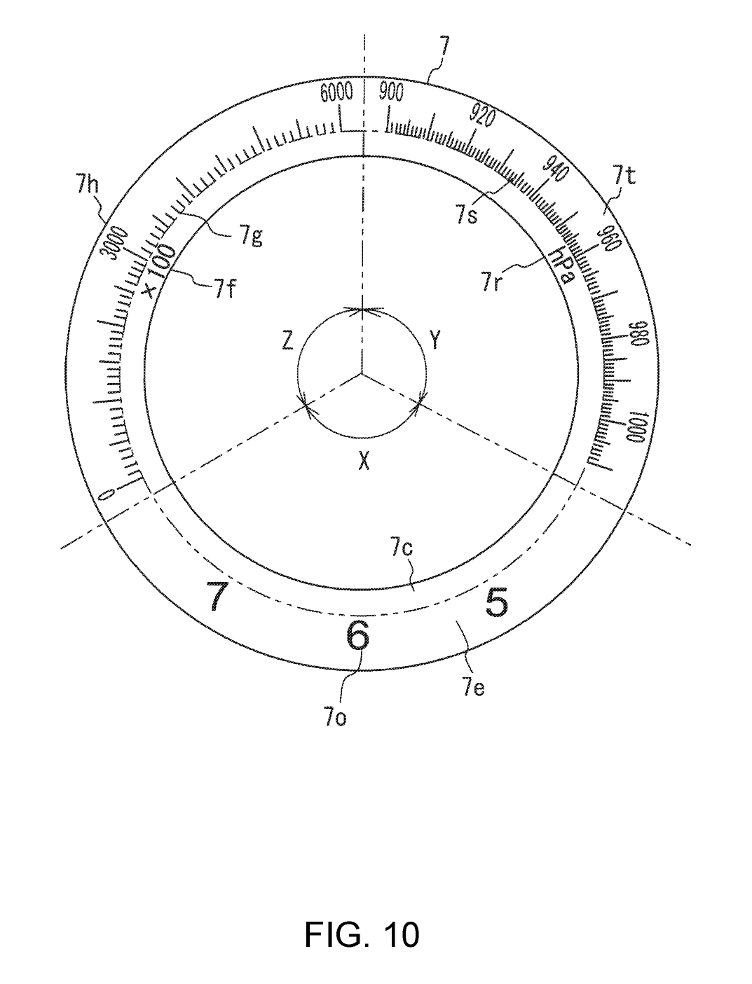

In the invention, a plurality of pairs of display ranges may be disposed instead of disposing only one pair so as to be symmetrical with respect to the central axis Z perpendicular to the circumferential direction of the circle of the dial ring 6. As illustrated in FIG. 9, one opening portion 6l may be formed on the dial ring 6 in an angular range equal to or smaller than a fraction of the circumference in the circumferential direction (in the illustrated example, an angular range smaller than one-third of the circle). FIG. 10 illustrates an example in which the inner rotation ring 7 is divided into display ranges X, Y, and Z as large as every one-third in the circumferential direction so as to correspond to the configuration of the opening portions in FIG. 9.

The example in FIGS. 9 and 10 adopts a configuration in which the dial ring 6 has the end surface 6a and the upper surface 6c, and in which the inner rotation ring 7 correspondingly has the end surface 7c and the upper surface 7e.

As illustrated in FIG. 9, a region other than the opening portion 6l of the dial ring 6 is set to serve as a display portion of a number 6k for indicating the time. As illustrated in FIG. 10, one display range X among the three display ranges of the inner rotation ring 7 is set to serve as the additional display 7o for displaying the numbers (5, 6, and 7) of “hour”, which are not displayed on the dial ring 6.

The other display range Y is set to serve as a display portion of the atmospheric pressure. The end surface 7c is set to serve as the additional display 7r for indicating the name (hPa) of the atmospheric pressure items. The upper surface 7e is set to serve as the additional display 7s for indicating the scales and the additional display 7t having the marked numerical values of the atmospheric pressure. The other display area Z is set to serve as a display portion of the altitude. The end surface 7c is set to serve as the additional display 7f for displaying the units of the altitude. The upper surface 7e is set to serve as the additional display 7g for indicating the scales and the additional display 7h having the marked numerical values of the altitude.

The embodiment illustrated in FIGS. 9 and 10 adopts a configuration as follows. Each time the operation button serving as the operation member 20 illustrated in FIG. 1 is pushed, the inner rotation ring 7 is rotated, and the display ranges exposed in the opening portion 6l are sequentially switched as in X, Y, and Z. When the display range is switched to Y and Z, similarly to the above-described embodiment, the second hand 5 indicates the scales as the indicating hand.

In the example illustrated in FIGS. 9 and 10, the upper surface 6c of the dial ring 6 or the upper surface 7e of the inner rotation ring 7 may have an inclined structure. The dial ring 6 or the inner rotation ring 7 may have a two surface structure having only the inclined surfaces 6b and 7d without the end surfaces 6a and 7c.

The invention is applicable to a case where what the items to be displayed on the additional displays do not require measurement. In a case of embodying the invention, various modifications and additions can be made for the configuration members and combinations thereof without departing from the gist of the invention.

What is claimed is:

1. An electronic timepiece having a display function other than a time display function, the electronic timepiece comprising:
a dial ring disposed in an outer peripheral portion of a dial inside an exterior case;
an opening portion disposed in the dial ring;
an inner rotation ring rotatably disposed inside the dial ring, and including an additional display having marked display content visible through the opening portion;
a control unit that controls a rotation amount of the inner rotation ring; and
an indicating hand that indicates the additional display.

2. The electronic timepiece according to claim 1,
wherein a plurality of additional displays having mutually different items to be displayed are dispersedly arranged in the inner rotation ring in a circumferential direction, and
the inner rotation ring is rotated by operating an operation member attached to the exterior case so that one of the plurality of additional displays is exposed in the opening portion disposed in the dial ring.

3. The electronic timepiece according to claim 1,
wherein the dial ring has a pair of opening portions including the opening portion, which are symmetrically arranged with respect to a center point of a circle of the dial ring.

4. The electronic timepiece according to claim 3,
wherein the inner rotation ring has a pair of the additional displays having the same display item and having mutually different numerical ranges, which are symmetrically arranged with respect to the center point of the circle of the inner rotation ring, and
each of the pair of additional displays is exposed in each of the pair of opening portions so that the indicating hand indicates one of the pair of additional displays.

5. The electronic timepiece according to claim 1,
wherein the dial ring includes an end surface having a shape perpendicular to a surface of the dial, an inclined surface having a shape obliquely rising from the end surface toward an outer peripheral side of the dial ring, and an upper surface disposed in a flat shape from the outer peripheral side of the inclined surface toward the outer peripheral side of the dial ring,
the inner rotation ring includes an end surface, an inclined surface, and an upper surface which respectively correspond to the end surface, the inclined surface, and the upper surface of the dial ring,
the end surface, the inclined surface, and the upper surface of the dial ring each have an opening portion, and
the additional displays are disposed in the end surface, the inclined surface, and the upper surface of the inner rotation ring so as to respectively correspond to the end surface, the inclined surface, and the upper surface of the dial ring.

6. The electronic timepiece according to claim 1,
wherein the dial ring includes two surface portions among an end surface having a shape perpendicular to a surface of the dial, an inclined surface having a shape obliquely rising from the end surface toward an outer peripheral side of the dial ring, and an upper surface disposed in a flat shape from the outer peripheral side of the inclined surface toward the outer peripheral side of the dial ring,
the inner rotation ring includes two surface portions respectively corresponding to the two surface portions of the dial ring,
the two surface portions included in the dial ring have the opening portion, and
the additional displays are disposed in the two surface portions included in the inner rotation ring so as to respectively correspond to the respective opening portions of the dial ring.

7. The electronic timepiece according to claim 1,
wherein as an indicating hand for indicating the additional display, a second hand is used in common, and
an operation member is attached to the exterior case, and the control unit has a function to switch a time display using the second hand to indication of the additional display by operating the operation member.
